(19) United States
(12) Patent Application Publication
(10) Pub. No.: US 2012/0214925 A1
(43) Pub. Date: Aug. 23, 2012

(54) Organosiloxane Compositions

(75) Inventors: Frederic Gubbels, Houtain-le-Val (BE); Stephanie Lobry, Rombies et Marchipoint (FR); Loriane Parisot, Forest (BE); Anne-Marie Van Stiphoudt, Wavre (BE)

(73) Assignee: Dow Corning Corporation, Midland, MI (US)

(21) Appl. No.: 13/503,930

(22) PCT Filed: Oct. 22, 2010
(86) PCT No.: PCT/EP10/65940

§ 371 Date: Apr. 25, 2012

(30) Foreign Application Priority Data
Oct. 26, 2009 (EP) EP 09306009.3
Oct. 22, 2010 (EP) PCT/EP2010/065940

(51) Int. Cl. C08L 83/06; C08K 3/26; C08K 3/10; C08K 3/22; C08K 3/34; B05D 3/00; C08K 3/30

(52) U.S. Cl. 524/413; 427/387; 524/500; 524/425; 524/423; 524/431; 524/451; 524/448; 524/456; 524/437; 524/424; 524/445; 524/436; 524/430; 524/444

(57) ABSTRACT

This invention relates to the use of silyl terminated organic polymers in phenylorganosiloxane based silicone sealant formulations containing silyl terminated organic polymers are described. Subsequent to cure the compositions, provide sealants exhibiting superior mechanical properties, particularly with respect to elongation, tensile strength and adhesion on glass. The composition comprises a phenylorganosiloxane having terminal groups selected from —OH or hydrolysable groups and unsaturated groups. Typically the phenylorganosiloxane has a viscosity of at least 10000 mPa.s at 25° C. Other ingredients include either: (i) one or more organic polymers having terminal and/or pendent silyl groups containing —OH functional groups or hydrolysable functional groups, or (ii) one or more organic polymers having terminal and/or pendent silyl groups containing one or more unsaturated groups, selected in accordance with the terminal groups of (a) as well as fillers, cross-linkers and catalyst.

This invention relates to the use of silyl terminated organic polymers in phenylorganosiloxane based silicone sealant formulations which, subsequent to cure, provide sealants exhibiting superior mechanical properties, particularly with respect to elongation, tensile strength and adhesion on glass.

Phenylorganosiloxane based materials in particular phenylalkylsiloxanes, such as phenylmethylsiloxanes, are known in the art to exhibit low gas permeability, making them particularly suitable for use in sealants for sealing spaces against the ingress/egress of gasses. Hence, phenylmethylsiloxanes having viscosities of at least 10000 mPa.s at 25° C., more preferably viscosities of greater than 100000 mPa.s at 25° C. are industrially highly desired polymers but have proven to be extremely difficult to manufacture other than in a copolymeric form. The use of a copolymer of dimethyl and phenylmethyl siloxane in a low gas permeable sealant has been disclosed in GB 2,249,552. The copolymer is used as a binder in combination with shaped fillers and the resulting sealant is used in sealing multiple-pane insulating glass units. These units typically comprise a plurality of panes of glass containing a gas, for example argon, in an interior space sealed at the periphery. Satisfactory sealing of the units is necessary since egress of argon gas from an insulating glass unit can lead to implosion of the unit. In such extreme cases, the sealant exhibits gas selectivity towards argon, nitrogen and oxygen. However the use of such a copolymer in a sealant formulation is of concern because of the presence of potentially hazardous by-products of the copolymerisation process, particularly 2,6-cis-diphenylhexamethylcyclotetrasiloxane, which is believed may impair fertility.

WO 2008/152042 describes the preparation and use of a phenylorganosiloxane polymer, typically a phenylalkylsiloxane, as a binder to formulate a low gas permeable sealant. The replacement of the copolymer used in GB 2,249,552 avoids the presence of by-products such as 2,6-cis-diphenylhexamethylcyclotetrasiloxane and further has been found to reduce the gas permeability of the system without the need for incorporating shaped fillers, to reach a gas permeability comparable to organic sealants.

WO 2006/128015 describes polymer compositions containing an organic compatibilizer polymer having silane reactive groups, from 1 to 45% by weight of a reactive or non-reactive organopolysiloxane and an organic polymer which does not contain silane groups. It is suggested that such a formulation does not phase separate as readily as compositions lacking the compatibilizer. EP0604851 describes an alkoxysilane functionalised acrylic polymer composition which additionally contains a silanol solution comprising reactive organopolysiloxanes having terminal —OH groups and aliphatic organic side chains together with silane cross-linkers. The composition of EP0604851 can be used in sealant formulations. US60602964 describes the use of a reactive silicone oligomer in a moisture curable silylated polyurethane and/or moisture curable silylated polyether including mixtures thereof which may be used in sealant formulations.

In accordance with the present invention there is provided a phenylorganosiloxane composition comprising
(a) 100 parts by weight of a phenylorganosiloxane having terminal groups selected from —

OH or hydrolysable groups and unsaturated groups having a viscosity of at least 10000 mPa.s at 25° C.;
(b) 40 to 75 parts by weight per 100 parts by weight of (a) of
   (i) one or more organic polymers having terminal and/or pendent silyl groups containing —OH functional groups or hydrolysable functional groups, or
   (ii) one or more organic polymers having terminal and/or pendent silyl groups containing one or more unsaturated groups, selected in accordance with the terminal groups of (a)
(c) 5 to 500 parts by weight of fillers per 100 parts by weight of (a),
(d) a suitable amount of one or more suitable crosslinkers for cross-linking (a) and (b) and
(e) a suitable amount of catalyst.

The composition may additionally contain optional additives such as, for example, extenders, plasticizers, adhesion promoters, light stabilizers and fungicides.

To our surprise, the addition of —OH functional or hydrolysable functional silyl terminated organic polymers or one or more unsaturated silyl terminated organic polymers such as a silyl terminated polyether or silyl terminated polyurethane increases the tensile strength, elongation at break and Young's modulus of the cured sealant. Furthermore, the adhesion of the composition on glass is improved. For example, the addition of 40 to 75 parts of silyl terminated organic polymers (b) with 100 parts of a phenyl methyl siloxane polymer (a) can lead to an improvement of elongation at break of from 25 to 80%.

The composition in accordance with the present invention is preferably a moisture curing sealant formulation but can also be an addition curing composition for any application. However, irrespective of the chosen chemistry the result of the curing process should involve the in-situ coupling of the two non miscible polymers (a) and (b).

The composition in accordance with the present invention may be stored as a one part composition or, alternatively may be provided in two or more parts, two parts being preferred (in the latter case they are combined immediately prior to use). Typically such multiple part compositions can have any suitable combination providing that neither part is able to pre-cure prior to mixing. For example, polymer, and filler may be present in a first part and the crosslinker, adhesion promoter (when present) and catalyst may be in the second part. In such cases organic polymer (b) may be retained in both the first part and the second part and in one embodiment one organic polymer (b) is present in the first part and a second organic polymer (b) is present in the second part of the composition. Optional additives may be present in either part.

The phenylorganosiloxane (a) is preferably a phenylalkylsiloxane containing silicon bonded terminal groups containing at least one of the following reactive units
(i) —OH or hydrolysable containing end groups; or
(ii) unsaturated end groups

In the case of (i) the hydrolysable end groups may be selected, for example, from alkoxy groups containing from 1 to 6 carbon atoms, oximo groups and acetoxy having up to 6 carbon atoms although any suitable hydrolysable groups which will cure with (b) (i) and the cross-linker may be utilised.

Preferably component (a) (i) of the composition is a higher MW phenylorganosiloxane (i.e. having a viscosity of at least 10000 mPa.s at 25° C.) of the structure:

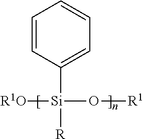

Where each R may be the same or different and may comprise a hydrocarbon group having from 1 to 18 carbon atoms, a substituted hydrocarbon group having from 1 to 18 carbon atoms or a hydrocarbonoxy group having up to 18 carbon atoms, n is a whole number of a size such that the viscosity thereof is in accordance with the invention and each R¹ is a terminal group of the formula

—Si—R²₃

In which each R² may be the same or different and is selected, in the case of (a)(i), from an alkyl group having from 1 to 6 carbon atoms, —OH, an alkoxy group having from 1 to 6 carbon atoms, an acetoxy group or an oximo group. Each polymer (a) must contain at least two groups selected from —OH, an alkoxy group having from 1 to 6 carbon atoms, an acetoxy group or an oximo group which may be R or R² groups. Alternatively each R¹ in (a) (i) must contain at least one R² selected from —OH, an alkoxy group having from 1 to 6 carbon atoms, an acetoxy group or an oximo group with —OH being preferred.

For the purpose of this application “Substituted” means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

Particularly preferred examples of groups R include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. Preferably, at least some and more preferably substantially all of the groups R are methyl. Some R groups may be hydrogen groups. Preferably the phenylorganosiloxane is a phenylalkylsiloxane. Preferably each alkyl group may be the same or is different and comprises from 1 to 6 carbon atoms. Preferably the phenylalkylsiloxane, is a phenylmethylsiloxane having a viscosity of at least 10,000 mPa.s at 25° C., more preferably a viscosity of greater than 100,000 mPa.s at 25° C. such as those prepared in accordance with the process described in WO 2008/152042 in which substantially pure higher molecular weight (MW) phenylalkylsiloxane is prepared from a lower MW phenylalkylsiloxane by polymerisation of the lower MW phenylalkylsiloxane under vacuum in the presence of an aqueous alkaline solution containing one or more alkalis selected from the group of sodium hydroxide, potassium hydroxide, magnesium hydroxide, calcium hydroxide, rubidium hydroxide, ammonium hydroxide, tetraalkylammonium hydroxide, tetraalkyl ammonium alkoxide and phosphonium hydroxides in an amount of from 50ppm or greater based upon the amount of lower MW phenylalkylsiloxane.

The phenylorganosiloxane may as indicated in alternative (a) (ii) contain unsaturated end groups. In this case for polymer (a) each R² may be the same or different and is selected, from an alkyl group having from 1 to 6 carbon atoms or a suitable unsaturated group and one or more R groups may be unsaturated. Suitable unsaturated groups include alkenyl groups having from 2 to 10 carbon atoms e.g. ethenyl, propenyl, allyl (CH₂═CHCH₂—)) or they may be acrylic or alkylacrylic such as CH₂═C(CH₃)—CH₂— groups. Representative, non-limiting examples of the alkenyl groups are shown by the following structures; H₂C═CH—, H₂C═CHCH₂—, H₂C═C(CH₃)CH₂—, H₂C═CHCH₂CH₂—, H₂C=CHCH₂CH₂CH₂—, and H₂C═CHCH₂CH₂CH₂CH₂—. Representative, non-limiting examples of alkynyl groups are shown by the following structures; HC≡C—, HC≡CCH₂—, HC≡CC(CH₃)—, HC≡CC(CH₃)₂— and HC≡CC(CH₃)₂CH₂—. Alternatively, the unsaturated organic group can be an organofunctional hydrocarbon such as an acrylate, methacrylate. Alkenyl groups, e.g. vinyl groups are particularly preferred. Each polymer (a) (ii) must contain at least two unsaturated groups as hereinbefore described groups which may be R or R² groups. Alternatively each R¹ group in (a) (ii) must contain at least one unsaturated group.

Component (b) is an organic polymer containing terminal and/or pendent silyl groups selected from polyurethane, a polyether, a polycarbonate, (meth)acrylate and a saturated hydrocarbon polymer such as polyisobutylene and/or mixtures thereof. The silyl groups in component (b) must contain reactive groups which will participate in the composition cure with the reactive groups of polymer (a) (i) or (ii) and the remaining ingredients, e.g. it must contain one or more —OH groups or hydrolysable groups when (a) has like terminal groups and similarly at least one unsaturated group when the silyl end groups in (a) also contain these. The silyl groups are preferably either all terminal groups or all pendent groups attached to the polymer backbone but may be a mixture of both.

Any suitable silylated polyurethane may be used as (b). However polyurethanes synthesized from polyols reacted with isocyanatosilanes are particularly preferred. Suitable polyols include polyoxyalkylene diols such as, for example, polyoxyethylene diol, polyoxypropylene diol, and polyoxybutylene diol, polyoxyalkylene triols, polytetramethylene glycols, polycaprolactone diols and triols, and the like. Other polyol compounds, including tetraols such as pentaerythritol, sorbitol, mannitol and the like may alternatively be used. Preferred polyols used in the present invention are polyoxypropylene diol with equivalent weights in the range of from about 500 to about 50,000; preferably, between about 10,000 and 30,000. Mixtures of polyols of various structures, molecular weights and/or functionalities may also be used.

Suitable polyurethane prepolymer intermediates include polyurethane polymers that can be prepared by the chain extension reaction of polyols with diisocyanates. Any suitable diisocyanates may be utilised. Examples include, for example, 2,4-toluene diisocyanate; 2,6-toluene diisocyanate; 4,4′-diphenyl-methanediisocyanate; isophorone diisocyanate; dicyclohexylmethane-4,4′diisocyanate; various liquid diphenylmethanediisocyanates containing a branch or a mixture of 2,4- and 4,4′ isomers and the like, and mixtures thereof. In one embodiment monols can be used in combination with the polyols for the purpose of modifying the mechanical properties of the final cured product.

Silane endcappers, which may be utilised in the preparation of said suitable and silyl terminated polyurethanes may be represented by the general formula:

Rⁱⁱ—Rⁱⁱⁱ—Si(X)ₙ(R′)₃₋ₙ

wherein Rⁱⁱⁱ is a divalent organic group; Rⁱ is alkyl or aryl, preferably having from 1 to 8 carbon atoms, X, in the case of (b) (i) is —OH or a hydrolysable group as described above for (a) (i) and for (b) (ii) an unsaturated group as described above for (a) (ii); and n is an integer from 1 to 3. Group Rⁱⁱ is an organo-functional group, which can react with either isocyanato or hydroxyl terminated polymers, such as isocyanato, primary or secondary amino, mercapto, or ureido functional groups.

Any suitable silyl terminated polyether may be utilised as (b). These are usually prepared by reacting an unsaturated group-containing polyether oligomer with a reactive silicon group-containing compound in the presence of a Group VIII transition metal catalyst, such as chloroplatinic acid. The polyether may for example be obtained by the ring-opening addition polymerization of a substituted or unsubstituted C2-12 epoxy compound such as an alkylene oxide, e.g. ethylene oxide, propylene oxide, [alpha]-butylene oxide, [beta]-butylene oxide, hexene oxide, cyclohexene oxide, styrene oxide and [alpha]-methylstyrene oxide or an alkyl, allyl or aryl glycidyl ether, e.g. methyl glycidyl ether, ethyl glycidyl ether, isopropyl glycidyl ether, butyl glycidyl ether, allyl glycidyl ether and phenyl glycidyl ether, using as polymerization initiator a dihydric or polyhydric alcohol, e.g. ethylene glycol, propylene glycol, butanediol, hexamethylene glycol, methallyl alcohol, hydrogenated bisphenol A, neopentyl glycol, polybutadienediol, diethylene glycol, triethylene glycol, polyethylene glycol, polypropylene glycol, polypropylene triol, polypropylenetetraol, dipropylene glycol, glycerol, trimethylolmethane, trimethylolpropane and pentaerythritol, or a hydroxyl-containing oligomer in the presence of a suitable catalyst.

The introduction of an unsaturated group into a hydroxy-terminated polyether oligomer can be achieved by any known method, for example by the method comprising reacting the hydroxy-terminated polyether oligomer with an unsaturated group-containing compound through bonding via e.g. ether linkages, ester linkages, or carbonate bonding. More specifically, examples of the organic polymer (A) include polyoxyalkylene polymers such as polyoxyethylene, polyoxypropylene, polyoxybutylene, polyoxytetramethylene, polyoxyethylene-polyoxypropylene copolymer, and polyoxyprolylene-polyoxybutylene copolymer. Preferably the polyoxyalkylene based blocks, are bonded with silanes or siloxanes via a hydrosilylation reaction, e.g. with an allyl polyether. Polyoxyalkylene blocks suitable for the current invention comprise a linear predominantly oxyalkylene polymer comprised of recurring oxyalkylene units, of the formula (—CₙH₂ₙ—O—); illustrated by the average formula (—CₙH₂ₙ—O—)_{y} wherein n is an integer from 2 to 4 inclusive and y is an integer of at least four. The number average molecular weight of each polyoxyalkylene polymer block may range from about 300 to about 50,000. Moreover, the oxyalkylene units are not necessarily identical throughout the polyoxyalkylene monomer, but can differ from unit to unit. A polyoxyalkylene block, for example, can be comprised of oxyethylene units, (—C₂H₄—O—); oxypropylene units (—C₃H₆—O—); or oxybutylene units, (—C₄H₈—O—); or mixtures thereof. Preferably the polyoxyalkylene polymeric backbone consists essentially of oxypropylene units.

Other polyoxyalkylene blocks may include for example: units of the structure—

—[—R^{e}—O—(—R^{f}—O—)ₕ-Pn—CR^{g}₂-Pn-O—(—R^{f}—O—)_{q}—R^{e}]—

in which Pn is a 1,4-phenylene group, each R^{e} is the same or different and is a divalent hydrocarbon group having 2 to 8 carbon atoms, each R^{f} is the same or different and, is, an ethylene group propylene group, or isopropylene group each R^{g} is the same or different and is a hydrogen atom or methyl group and each of the subscripts h and q is a positive integer in the range from 3 to 30. The silyl terminal group contains either an —OH group or an unsaturated group of the type previously discussed above.

Any suitable silyl terminated (meth)acrylate polymer may be utilised as (b). These may include for example (meth)acrylate polymers obtained by radical polymerization of the monomers such as ethyl(meth)acrylate and butyl(meth)acrylate; vinyl polymers obtained by radical polymerization of (meth)acrylate monomers. Alternatively, silyl terminated saturated hydrocarbon polymers such as polyisobutylene, hydrogenated polyisoprene, and hydrogenated polybutadiene may alternatively be utilised as (b). Each silyl terminal group contains at least one —OH group, a hydrolysable group or an unsaturated group of the type previously discussed above.

In one embodiment of the present invention either component (a) or component (b) has a relatively low viscosity (i.e. low molecular weight) which upon curing will result in the preparation of a low modulus sealant.

Compositions in accordance with the present invention contain one or more finely divided, reinforcing fillers (c) such as high surface area fumed and precipitated silicas, calcium carbonate or additional non-reinforcing fillers such as crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, magnesium carbonate, clays such as kaolin, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite

Aluminium oxide, silicates from the group consisting of olivine group; garnet group;

aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅ ; mullite; 3Al₂O₃.2SiO₂; kyanite; and Al₂SiO₅ The ring silicates group comprises silicate minerals, such as but not limited to, cordierite and A1₃(Mg,Fe)₂[Si₄AlO₁₈].

The chain silicates group comprises ground silicate minerals, such as but not limited to, wollastonite and Ca[SiO₃].

The sheet silicates group comprises silicate minerals, such as but not limited to, mica; K₂Al₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite.

In addition, a surface treatment of the filler(s) may be performed, for example with a fatty acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other sealant components. The surface treatment of the fillers makes the ground silicate minerals easily wetted by the silicone polymer. These surface modified fillers do not clump, and can be homogeneously incorporated into the silicone polymer. This results in improved room temperature mechanical properties of the uncured compositions. Furthermore, the surface treated fillers give a lower conductivity than untreated or raw material.

The proportion of such fillers when employed will depend on the properties desired in the elastomer-forming composition and the cured elastomer. Usually the filler content of the composition will reside within the range from about 5 to about 500 parts by weight per 100 parts by weight of the polymer (a). A range of from 50 to 400 parts by weight per 100 parts by weight of the polymer (a) is preferred.

Any suitable cross-linker may be used as (d). A suitable cross-linker (d) when (a) and (b) contain —OH or hydrolysable terminal groups may contain three silicon-bonded hydrolysable groups per molecule; the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably however, the fourth silicon-bonded organic group is methyl or ethyl.

Specific examples of cross-linkers include alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate and dimethyltetraacetoxydisiloxane.

The cross-linker when (a) and (b) contain —OH terminal groups may also comprise a disilaalkane of the formula:

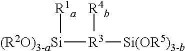

where R¹ and R⁴ are monovalent hydrocarbons, R² and R⁵ are alkyl groups or alkoxylated alkyl groups, R³ is a divalent hydrocarbon group and a and b are 0 or 1. Specific examples include 1,6-bis(trimethoxysilyl)hexane, 1,1-bis(trimethoxysilyl)ethane, 1,2-bis(trimethoxysilyl)ethane, 1,2-bis(trimethoxysilyl)propane, 1,1-bis(methyldimethoxysilyl)ethane, 1,2-bis(triethoxysilyl)ethane, 1-trimethoxysilyl-2-methyldimethoxysilylethane, 1,3-bis(trimethoxyethoxysilyl)propane, and 1-dimethylmethoxysilyl-2-phenyldiethoxysilylethane.

Further alternative cross-linkers include Alkylalkenylbis(N-alkylacetamido) silanes such as methylvinyldi-(N-methylacetamido)silane, and methylvinyldi-(N-ethylacetamido)silane; dialkylbis(N-arylacetamido) silanes such as dimethyldi-(N-methylacetamido)silane; and dimethyldi-(N-ethylacetamido)silane; Alkylalkenylbis(N-arylacetamido) silanes such as methylvinyldi(N-phenylacetamido)silane and dialkylbis(N-arylacetamido) silanes such as dimethyldi-(N-phenylacetamido)silane. The cross-linker used may also comprise any combination of two or more of the above. A particularly preferred cross-linker is 1,6-bis(trimethoxysilyl)hexane.

The cross-linker used may also comprise any combination of two or more of the above. Preferably condensation cross-linkers are present in the composition in a range of about 0.1 to 10% by weight of the composition.

In the case when (a) and (b) contain unsaturated terminal groups the cure process will proceed via a hydrosilylation reaction pathway and hence the cross-linker will typically contain 3 or more silicon bonded hydrogen groups. To effect curing of the present composition, the organohydrogensiloxane must contain more than two silicon bonded hydrogen atoms per molecule. The organohydrogensiloxane can contain, for example, from about 4-200 silicon atoms per molecule, and preferably from about 4 to 50 silicon atoms per molecule and have a viscosity of up to about 10 Pa·s at 25 ° C. The silicon-bonded organic groups present in the organohydrogensiloxane can include substituted and unsubstituted alkyl groups of 1-4 carbon atoms that are otherwise free of ethylenic or acetylenic unsaturation. Preferably each organohydrogensiloxane molecule comprises at least 3 silicon-bonded hydrogen atoms in an amount which is sufficient to give a molar ratio of Si—H groups in the organohydrogensiloxane to the total amount of alkenyl groups in polymers (a) and (b) of from 1/1 to 10/1.

When (a) and (b) have —OH or hydrolysable terminal groups, any suitable condensation catalyst (d) may be utilised to cure the composition these include condensation catalysts including tin, lead, antimony, iron, cadmium, barium, manganese, zinc, chromium, cobalt, nickel, aluminium, gallium or germanium and zirconium. Examples include organic tin metal catalysts such as triethyltin tartrate, tin octoate, tin oleate, tin naphthate, butyltintri-2-ethylhexoate, tinbutyrate, carbomethoxyphenyl tin trisuberate, isobutyltintriceroate, and diorganotin salts especially diorganotin dicarboxylate compounds such as dibutyltin dilaurate, dimethyltin dibutyrate, dibutyltin dimethoxide, dibutyltin diacetate, dimethyltin bisneodecanoate Dibutyltin dibenzoate, stannous octoate, dimethyltin dineodeconoate, dibutyltin dioctoate of which stannous octoates is particularly preferred. Other examples include 2-ethylhexoates of iron, cobalt, manganese, lead and zinc.

Alternative condensation catalysts include titanate or zirconate compounds. Such titanates may comprise a compound according to the general formula Ti[OR]₄ where each R may be the same or different and represents a monovalent, primary, secondary or tertiary aliphatic hydrocarbon group which may be linear or branched containing from 1 to 10 carbon atoms. Optionally the titanate may contain partially unsaturated groups. However, preferred examples of R include but are not restricted to methyl, ethyl, propyl, isopropyl, butyl, tertiary butyl and a branched secondary alkyl group such as 2,4-dimethyl-3-pentyl. Preferably, when each R is the same, R is an unbranched secondary alkyl groups, branched secondary alkyl group or a tertiary alkyl group, in particular, tertiary butyl such as tetrabutyltitanate, tetraisopropyltitanate.

For the avoidance of doubt an unbranched secondary alkyl group is intended to mean a linear organic chain which does not have a subordinate chain containing one or more carbon atoms, i.e. an isopropyl group, whilst a branched secondary alkyl group has a subordinate chain of one or more carbon atoms such as 2,4-dimethyl-3-pentyl.

Any suitable chelated titanates or zirconates may be utilised. Preferably the chelate group used is a monoketoester such as acetylacetonate and alkylacetoacetonate giving chelated titanates such as, for example diisopropyl bis(acetylacetonyl)titanate, diisopropyl bis(ethylacetoacetonyl)titanate, diisopropoxytitanium Bis(Ethylacetoacetate) and the like. Examples of suitable catalysts are additionally described in EP1254192 and WO200149774 which are incorporated herein by reference.

In the case where the silyl terminal groups in (a) and (b) contain unsaturated groups suitable hydrosilylation catalysts are used. These are typically platinum group metal based catalysts selected from a platinum, rhodium, iridium, palladium or ruthenium catalyst. Platinum group metal containing catalysts useful to catalyse curing of the present compositions can be any of those known to catalyse reactions of silicon bonded hydrogen atoms with silicon bonded alkenyl groups. The preferred platinum group metal for use as a catalyst to effect cure of the present compositions by hydrosilylation is platinum. Some preferred platinum based hydrosilylation catalysts for curing the present composition are platinum metal, platinum compounds and platinum complexes. Representative platinum compounds include chloroplatinic acid, chloroplatinic acid hexahydrate, platinum dichloride, and complexes of such compounds containing low molecular weight vinyl containing organosiloxanes.

The platinum group metal containing catalyst may be added to the present composition in an amount equivalent to as little as 0.001 part by weight of elemental platinum group metal, per one million parts (ppm) of the composition. Preferably, the concentration of platinum group metal in the composition is capable of providing the equivalent of at least 1 part per million of elemental platinum group metal. A catalyst concentration providing the equivalent of about 3-50 parts per million of elemental platinum group metal is generally the amount preferred.

To obtain a longer working time or “pot life”, the activity of hydrosilylation catalysts under ambient conditions can be retarded or suppressed by addition of a suitable inhibitor. Known platinum group metal catalyst inhibitors include the acetylenic compounds disclosed in U.S. Pat. No. 3,445,420. Acetylenic alcohols such as 2-methyl-3-butyn-2-ol and 1-ethynyl-2-cyclohexanol constitute a preferred class of inhibitors that suppress the activity of a platinum-based catalyst at 25° C. Compositions containing these catalysts typically require heating at temperatures of 70° C. or above to cure at a practical rate. Room temperature cure is typically accomplished with such systems by use of a two-part system in which the crosslinker and inhibitor are in one of the two parts and the platinum is in the other part. The amount of platinum is increased to allow for curing at room temperature.

The composition in accordance with the present invention provides the user with formulations suitable for applications including, sealants formulations.

Other ingredients which may be included in the compositions include but are not restricted to adhesion promoters, pigments, UV stabilizers, fungicides and/or biocides and the like (which may suitably be present in an amount of from 0 to 0.3% by weight), water scavengers, (typically the same compounds as those used as cross-linkers or silazanes). It will be appreciated that some of the additives are included in more than one list of additives. Such additives would then have the ability to function in all the different ways referred to.

A suitable plasticiser or extender may also be utilised in the sealant composition in accordance with the present invention. A plasticiser (sometimes referred to as a primary plasticiser) may be added to a polymer composition to provide properties within the final polymer based product e.g. to increase the flexibility and toughness of the final polymer composition.

Typically, for silicone based compositions plasticisers are organopolysiloxanes which are unreactive with the siloxane polymer of the composition, such as polydimethylsiloxane having terminal triorganosiloxy groups wherein the organic substituents are, for example, methyl, vinyl or phenyl or combinations of these groups. Such polydimethylsiloxanes normally have a viscosity of from about 5 to about 100,000 mPa.s at 25° C. Compatible organic plasticisers may additionally be used, examples include dialkyl phthalates wherein the alkyl group may be linear and/or branched and contains from six to 20 carbon atoms such as dioctyl, dihexyl, dinonyl, didecyl, diallanyl and other phthalates; adipate, azelate, oleate and sebacate esters, polyols such as ethylene glycol and its derivatives, organic phosphates such as tricresyl phosphate and/or triphenyl phosphates.

Typically plasticisers are more compatible with polymer compositions than extenders and tend to be significantly less volatile and as such are significantly more likely to remain at high levels within the polymer matrix after curing.

Extenders need to be both sufficiently compatible with the remainder of the composition and as non-volatile as possible at the temperature at which the resulting cured elastomeric solid is to be maintained (e.g. room temperature).

A wide variety of organic compounds and compositions have been proposed for use as extenders for reducing the cost of the silicone sealant compositions. Whilst polyalkylbenzenes such as heavy alkylates (alkylated aromatic materials remaining after distillation of oil in a refinery) have been proposed as extender materials for silicone sealant compositions in recent years, the industry has increasingly used mineral oil based (typically petroleum based) paraffinic hydrocarbons as extenders as reviewed GB 2424898 the content of which is enclosed herein by reference.

Any suitable one or more plasticiser(s) and/or extender(s), e.g. those discussed in GB 2424898 may be utilised providing they are compatible with both (a) and (b) in the composition in accordance with the invention in order to aid compatibilisation thereof in the cured composition leading to improved mechanical properties. The plasticiser(s) and/or extender(s) may be present in an amount of 0 to 100 parts by weight per 100 parts by weight of component (a), alternatively in an amount of 0 to 40 parts by weight per 100 parts by weight of component (a) and in a further alternative 0.1 to 40 parts by weight per 100 parts by weight of component (a).

Any suitable adhesion promoter(s) may be incorporated in a sealant composition in accordance with the present invention. These may include for example alkoxy silanes such as aminoalkylalkoxy silanes, epoxyalkylalkoxy silanes, for example, 3-glycidoxypropyltrimethoxysilane and, mercapto-alkylalkoxy silanes and γ-aminopropyl triethoxysilane, reaction products of ethylenediamine with silylacrylates. Isocyanurates containing silicon groups such as 1,3,5-tris(trialkoxysilylalkyl) isocyanurates may additionally be used. Further suitable adhesion promoters are reaction products of epoxyalkylalkoxy silanes such as 3-glycidoxypropyltrimethoxysilane with amino-substituted alkoxysilanes such as 3-aminopropyltrimethoxysilane and optionally alkylalkoxy silanes such as methyl-trimethoxysilane. epoxyalkylalkoxy silane, mercaptoalkylalkoxy silane, and derivatives thereof.

In a preferred embodiment of the present invention there is provided a sealant composition comprising, in addition to polymers (a) and (b), 0 to 40% by weight of one or more plasticizers and/or one or more extenders, such as a mineral oil, a phthalate, or a low MW trialkylsilyl terminated polysiloxane, 0 to 10% of a rheological additive, 0 to 85% of an inorganic filler or a mixture of inorganic fillers such as calcium carbonate, silica, aluminum oxide, mica or kaolin, 0.1 to 10% of a crosslinker 0.01% to 5% of an adhesion promoter, and 0.01 to 5% of a catalyst based on tin, titanium, aluminum, zirconium, or bismuth, with the total cumulative weight of the composition in any such combination being weight 100%.

In a further embodiment of the invention there is provided the use of a phenylorganosiloxane composition as hereinbefore described as a sealant. Furthermore there is provided a method of sealing a space between two units, said method comprising applying a composition in accordance with any of claims 1 to 14 and causing or allowing the composition to cure. When the composition is stored in two parts the two parts of the composition need to be mixed prior to application. There is also provided a glazing structure or building unit which includes a sealant as hereinbefore described.

The present invention will now be described in detail by way of the following Examples in which all viscosity measurements were taken at 25° C. using a recording Brookfield viscometer according to ASTM D-3236 test method unless otherwise indicated. Molecular weight was measured by triple detection size exclusion chromatography in toluene using polystyrene standards.

### EXAMPLE 1 AND 2

### Sealant Base Mixing Procedure

1212.1 g of an OH terminated polyphenylmethylsiloxane of a molecular weight ca 28,000 produced in the lab according to WO2008/152042 (the content of which is hereby incorporated), and 242.4 g of an alkyl (C7 -C8 -C9) benzyl phthalate sold under the Trade name Santicizer® 261 by Ferro were incorporated into a mixer and mixed for 2 minutes at room temperature. Thereafter, 1333.3 g of a fatty acid treated ground calcium carbonate sold under the Trade name Mickart® AC supplied by La Provencale was added and mixed for 5 minutes at room temperature. 606 g of an ultrafine, stearic acid treated precipitated calcium carbonate sold as Socal® 312N supplied by Solvay were then added and mixed for 5 minutes at room temperature, followed by the addition of another 606 g aliquot of Socal® 312N mixed for 5 minutes at room temperature. A dynamic vacuum was applied for 10 minutes prior to the addition of 16 g of water. The compound was first mixed for 5 minutes at room temperature then was mixed for 5 minutes under a static vacuum. The sealant was then extruded in semco cartridges with the help of a press on the mixing pot and stored at room temperature.

### Sealant Cure Package (Containing the Catalyst and Cross-Linker(s)) Mixing Procedure

A predetermined quantity of silyl terminated polyurethane sold under the trade name Desmoseal S XP 2636 by Bayer was first poured in a dental container, followed by the addition of a predetermined quantity of (a) 1,6-bis(trimethoxysilyl)hexane, (b) [3-(2-aminoethyl)aminopropyl]trimethoxysilane and (c) stannous octoate. The mixture was mixed twice for 30 seconds.

### Sealant Preparation

Subsequent to the above mixing procedure the cure package was introduced into the sealant base semco cartridge in proportion described in table 1. The product was mixed for 125 cycles in the semco mixer and extruded to produce 12×12×50 mm³ tensile testing samples on a glass substrate.

### Sample Testing

The tensile adhesion joints were prepared with glass using polytetrafluoroethylene (PTFE) parts to facilitate demolding. The non tin side of float glass was selected using a UV lamp and cleaned with a mixture of isopropanol (IPA)/acetone 75/25 one hour prior to the application of the sealant. The sealed tensile pieces were left to cure in a climatic chamber for the mentioned number of days at 23° C. and 50% relative humidity. After this conditioning time period, the tensile adhesion joints were tested on a Zwick tensiometer in accordance with the ISO 8339 standard at a deformation speed of 5.5 mm/min until rupture. The Young's modulus is the slope at the origin of the stress strain plot expressed in MPa. The tensile strength is the maximum stress recorded during the testing expressed in Mpa. The elongation is the strain at break of the tensile adhesion joint expressed in %. The mode of rupture of the tensile joints was recorded according to the following rules: A failure occurring in the bulk of the sealant is recorded as a cohesive failure. A failure occurring between the sealant and the substrate leaving no trace of sealant on the substrate was recorded as an adhesive failure. A failure occurring between the sealant and the substrate but leaving a thin layer of sealant on the substrate was recorded as a boundary failure. An average of 3 values is reported in the result table.

### EXAMPLE 3

### Sealant Base Mixing Procedure

1126.8 g of an —OH terminated polyphenylmethylsiloxane of a molecular weight ca 28,000 produced in the lab according to WO2008/152042, 225.4 g of Santicizer® 261 and 281.7 g of a dimethoxymethylsilyl terminated polyether sold under the trade name Kaneka® MS S203H by the Kaneka Corporation were incorporated into a mixer and mixed for 2 minutes at room temperature. Thereafter, 1239.4 g of Mickart® AC was added and mixed for 5 minutes at room temperature. 563.4 g of Socal® 312N was then added and mixed for 5 minutes at room temperature, followed by the addition of a further 563.4 g aliquot of Socal® 312N mixed for 5 minutes at room temperature. A dynamic vacuum was applied for 10 minutes prior to the addition of 16 g of water. The compound was first mixed for 5 minutes at room temperature then was mixed for 5 minutes under a static vacuum. The sealant was then extruded in semco cartridges with the help of a press on the mixing pot and stored at room temperature.

### Sealant Cure Package Mixing Procedure

The cure package was prepared using a dental mixer. A predetermined quantity of Desmoseal S XP 2636 was first poured in the dental container, followed by the addition of a predetermined quantity of (a) carbon black sold under the Trade name SR511 by Sid Richardson, (b) 1,6-bis(trimethoxysilyl)hexane, (c) [3-(2-aminoethyl)aminopropyl]trimethoxysilane and (d) stannous octoate. The mixture was mixed twice for 30 seconds. The sealant was then prepared and applied onto glass for testing as hereinbefore described.

### EXAMPLE 4

### Sealant Base Mixing Procedure

1126.8 g of an —OH terminated polyphenylmethylsiloxane of a molecular weight ca 28,000 produced in the lab according to WO2008/152042, 225.4 g of Santicizer® 261 and 281.7 g of MS 5203H were incorporated into a mixer and mixed for 2 minutes at room temperature. Thereafter, 1239.4 g of Mickart AC were added and mixed for 5 minutes at room temperature. 563.4 g of Socal® 312N were then added and mixed for 5 minutes at room temperature, followed by the addition of another 563.4 g aliquot of Socal® 312N mixed for 5 minutes at room temperature. A dynamic vacuum was applied for 10 minutes prior to the addition of 16 g of water. The compound was first mixed for 5 minutes at room temperature then was mixed for 5 minutes under a static vacuum. The sealant was then extruded in semco cartridges with the help of a press on the mixing pot and stored at room temperature.

The cure package was prepared as described in Example 3 replacing Desmoseal S XP 2636 by Desmoseal S XP 2479 and then the sealant was then prepared and applied onto glass for testing as hereinbefore described.

### EXAMPLE 5

### Sealant Base Mixing Procedure

1126.8 g of an —OH terminated polyphenylmethylsiloxane of a molecular weight ca 15,000 produced in the lab according to WO2008/152042, 225.4 g of Santicizer® 261 and 281.7 g of MS 5203H were incorporated into a mixer and mixed for 2 minutes at room temperature. Thereafter, 1239.4 g of Mickart AC were added and mixed for 5 minutes at room temperature. 563.4 g of Socal® 312N were then added and mixed for 5 minutes at room temperature, followed by the addition of another 563.4 g aliquot of Socal® 312N mixed for 5 minutes at room temperature. A dynamic vacuum was applied for 10 minutes prior to the addition of 16 g of water. The compound was first mixed for 5 minutes at room temperature then was mixed for 5 minutes under a static vacuum. The sealant was then extruded in semco cartridges with the help of a press on the mixing pot and stored at room temperature.

The cure package was prepared as described in Example 3 and then the sealant was then prepared and applied onto glass for testing as hereinbefore described.

### COMPARATIVE EXAMPLE 1 to 5

### Sealant Base Mixing Procedure

1212.1 g of an —OH terminated polyphenylmethylsiloxane of a molecular weight ca 28,000 produced in the lab according to WO2008/152042, 242.4 g of Santicizer® 261 were incorporated into a mixer and mixed for 2 minutes at room temperature. Thereafter, 1333.3 g of Mickart AC was added and mixed for 5 minutes at room temperature. 606 g of Socal® 312N was then added and mixed for 5 minutes at room temperature, followed by the addition of another 606 g aliquot of Socal® 312N mixed for 5 minutes at room temperature. A dynamic vacuum was applied for 10 minutes prior to the addition of 16 g of water. The compound was first mixed for 5 minutes at room temperature then was mixed for 5 minutes under a static vacuum. The sealant was then extruded in semco cartridges with the help of a press on the mixing pot and stored at room temperature.

The cure package was prepared as described in Example 1 and then the sealant was then prepared and applied onto glass for testing as hereinbefore described.

### COMPARATIVE EXAMPLE 6

### Sealant Base Mixing Procedure

1578.9 g of an OH terminated polyphenylmethylsiloxane of a molecular weight ca 28,000 produced in the lab according to WO2008/152042, 210.5 g of Santicizer® 261 were incorporated into a mixer and mixed for 2 minutes at room temperature. Thereafter, 1157.9 g of Mickart AC was added and mixed for 5 minutes at room temperature. 526.3 g of Socal® 312N were then added and mixed for 5 minutes at room temperature, followed by the addition of another 526.3 g aliquot of Socal® 312N mixed for 5 minutes at room temperature. A dynamic vacuum was applied for 10 minutes prior to the addition of 16 g of water. The compound was first mixed for 5 minutes at room temperature then was mixed for 5 minutes under a static vacuum. The sealant was then extruded in semco cartridges with the help of a press on the mixing pot and stored at room temperature.

The cure package was prepared as described in Example 1 and then the sealant was then prepared and applied onto glass for testing as hereinbefore described.

### COMPARATIVE EXAMPLE 7

### Sealant Base Mixing Procedure

1126.8 g of an —OH terminated polyphenylmethylsiloxane of a molecular weight ca 28,000 produced in the lab according to WO2008/152042, 225.4 g of Santicizer® Santicizer 261 and 281.7 g of MS 5203H were incorporated into a mixer and mixed for 2 minutes at room temperature. Thereafter, 1239.4 g of Mickart AC were added and mixed for 5 minutes at room temperature. 563.4 g of Socal® 312N was then added and mixed for 5 minutes at room temperature, followed by the addition of another 563.4 g aliquot of Socal® 312N mixed for 5 minutes at room temperature. A dynamic vacuum was applied for 10 minutes prior to the addition of 16 g of water. The compound was first mixed for 5 minutes at room temperature then was mixed for 5 minutes under a static vacuum. The sealant was then extruded in semco cartridges with the help of a press on the mixing pot and stored at room temperature.

The cure package was prepared as described in Example 3, with the exception that the Desmoseal S XP 2636 was replaced by MS 5203H and then the sealant was then prepared and applied onto glass for testing as hereinbefore described.

### COMPARATIVE EXAMPLE 8

### Sealant Mixing Procedure

27.86 g of Desmoseal S XP 2636, 10 g of an —OH terminated polyphenylmethylsiloxane having a viscosity of 80,000 mPa.s at 25° C., 10 g of an ‘3OH terminated polyphenylmethylsiloxane having a viscosity of 20,000 mPa.s at 25° C., 0.5 g of a carboxylated polybutadiene rheological additive were incorporated into a dental mixer and mixed for 30 seconds at room temperature 40 g of Socal® 312N and 0.5 g of fumed silica sold as Cabot LM 150 by the Cabot Corporation was then added and mixed for twice 30 seconds. 1 g of hexamethyldisilazane and 1 g of vinyltrimethoxysilane have been added and mixed for 30 seconds. The following procedure was then carried out five times: the mixture was mixed for 30 seconds and then a vacuum of 5 minutes has been applied. 6.5 g of titanium dioxide, 0.4 g of Bis(1,2,2,6,6-pentamethyl-4-piperidyl) sebacate were added and mixed for twice 30 seconds. Then 0.8 g of methyltrismethylethylketoximosilane, 0.8 g of vinyltrismethylethylketoximosilane, 0.1 g of aminopropyltriethoxysilane, 0.5 g of aminoethylaminopropyltrimethoxysilane have been added and mixed for twice 30 seconds. Finally 0.04 g of dibutyl diacetato tin has been added and mixed for twice 30 seconds. The sealant was then filled in semco cartridges and the sealant was then and applied onto glass for testing as hereinbefore described.

TABLE 1
Formulations of Example 1-2 and Comparative Examples 1-6 (Parts Per 100 Parts of OH Terminated Phenylmethyl
Polymer)

| | Comp. | Comp. | Comp. | Comp. | | | Comp. | Comp. |
|---|---|---|---|---|---|---|---|---|
| | Ex 1 | Ex 2 | Ex 3 | Ex 4 | Ex 1 | Ex 2 | Ex 5 | Ex 6 |
| Base | | | | | | | | |
| OH terminated phenylmethyl polymer | 100 | 100 | 100 | 100 | 100 | 100 | 100 | 150 |
| Santicizer 261A | 20 | 20 | 20 | 20 | 20 | 20 | 20 | 20 |
| Mickart AC | 110 | 110 | 110 | 110 | 110 | 110 | 110 | 110 |
| Socal 312N | 100 | 100 | 100 | 100 | 100 | 100 | 100 | 100 |
| Cure Package | | | | | | | | |
| silyl terminated polyurethane (SXP 2636) | 0 | 10 | 20 | 30 | 40 | 50 | 100 | 0 |
| 1,6-bis(trimethoxysilyl)hexane | 4 | 4 | 4 | 4 | 4 | 4 | 4 | 4 |
| [3-(2-aminoethyl)aminopropyl]trimethoxysilane | 0.5 | 0.5 | 0.5 | 0.5 | 0.5 | 0.5 | 0.5 | 0.5 |
| Stannous Octoate | 2 | 2 | 2 | 2 | 2 | 2 | 2 | 2 |
| 7D Tensile testing on glass | | | | | | | | |
| Young modulus (MPa) | 2.0 | 1.9 | 2.1 | 2.5 | 2.5 | 2.2 | 1.97 | 1.69 |
| Elongation (%) | 20 | 43 | 69 | 64 | 75 | 94 | 78 | 58 |
| Tensile Strength (MPa) | 0.34 | 0.47 | 0.57 | 0.61 | 0.70 | 0.66 | 0.78 | 0.52 |
| Adhesion failure mode | BF | BF/CF | CF | CF | CF | CF | AF | BF/CF |
| 14D Tensile testing on glass | | | | | | | | |
| Young modulus (MPa) | 2.0 | 1.9 | 2.0 | 2.0 | 2.2 | 2.3 | 1.77 | 1.86 |
| Elongation (%) | 17 | 36 | 34 | 50 | 63 | 86 | 78 | 47 |
| Tensile Strength (MPa) | 0.30 | 0.48 | 0.47 | 0.64 | 0.75 | 0.77 | 0.78 | 0.53 |
| Adhesion failure mode | BF | BF/CF | BF | BF/CF | CF | CF | BF/CF | BF |

BF = boundary failure, which means that there is a very thin layer of sealant remaining on the surface of the glass
CF = cohesive failure, which means that the failure is occurring in the bulk of the sealant
BF/CF is a mixed mode of failure where a thick layer of sealant is remaining on the surface of the glass.

TABLE 2
Formulations of Example 3-5 and Comparative Example 7
(Parts Per 100 Parts of OH Terminated Phenylmethyl Polymer)

| | | | | Comp. |
|---|---|---|---|---|
| | Ex. 3 | Ex. 4 | Ex. 5 | Ex 7 |
| Base | | | | |
| OH terminated phenylmethyl | 100/0 | 100/0 | 0/100 | 100/0 |
| polymer 28,000/15,000 | | | | |
| Santicizer 261A | 20 | 20 | 20 | 20 |
| Kaneka MS S203H | 25 | 25 | 25 | 25 |
| Mickart AC | 110 | 110 | 110 | 110 |
| Socal 312N | 100 | 100 | 100 | 100 |
| Cure Package | | | | |
| silyl terminated polyurethane | 25/0 | 0/25 | 25/0 | 0/0 |
| SXP2636/SXP2479 | | | | |
| Kaneka MS S203H | 0 | 0 | 0 | 25 |
| 1,6-bis(trimethoxysilyl)hexane | 4 | 4 | 4 | 4 |
| [3-(2-aminoethyl)amino- | 0.5 | 0.5 | 0.5 | 0.5 |
| propyl]trimethoxysilane | | | | |
| Carbon black | 1 | 1 | 1 | 1 |
| Stannous Octoate | 2 | 2 | 2 | 2 |
| 7D Tensile testing on glass | | | | |
| Young modulus (MPa) | 1.86 | 2.27 | 2.62 | 1.21 |
| Elongation (%) | 51 | 42 | 46 | 37.27 |
| Tensile Strength (MPa) | 0.60 | 0.62 | 0.79 | 0.36 |
| Adhesion failure mode | CF | AF | BF/CF | BF/CF |
| 14D Tensile testing on glass | | | | |
| Young modulus (MPa) | 1.92 | 2.75 | 2.83 | 1.43 |
| Elongation (%) | 55 | 38 | 45 | 38.16 |
| Tensile Strength (MPa) | 0.83 | 0.70 | 0.82 | 0.46 |
| Adhesion failure mode | CF | BF/CF | BF/CF | BF/CF |

TABLE 3
Comparative example 8

| | Comp. Ex 8 |
|---|---|
| | (%) |
| Ingredients | |
| silyl terminated polyurethane (SXP 2636) | 27.86 |
| OH terminated phenylmethyl polymer | 10 |
| 80,000 mPa · s @ 25° C. | |
| OH terminated phenylmethyl polymer | 10 |
| 20,000 mPa · s @ 25° C. | |
| Rheological additive | 0.5 |
| Coated precipitated calcium carbonate | 40 |
| Fumed silica | 0.5 |
| Hexamethyldisilazane | 1 |
| Vinyltrimethoxysilane | 1 |
| Titanium dioxide | 6.5 |
| UV stabilizer | 0.4 |
| Methyltrismethylethylketoximosilane | 0.8 |
| Vinyltrismethylethylketoximosilane | 0.8 |
| Aminopropyltriethoxysilane | 0.1 |
| Aminoethylaminopropyltrimethoxysilane | 0.5 |
| Dibutyltindiacetate | 0.04 |
| 7D Tensile testing on glass | |
| Young modulus (MPa) | 1.91 |
| Elongation (%) | 130.01 |
| Tensile Strength (MPa) | 1.06 |
| Adhesion failure mode | AF |
| 14D Tensile testing on glass | |
| Young modulus (MPa) | 1.85 |
| Elongation (%) | 177.06 |
| Tensile Strength (MPa) | 1.12 |
| Adhesion failure mode | AF |

Table 1 is highlighting that best results for adhesion and elongation are obtained when the amount of silyl terminated polyurethane is present in the amount of 40 to 75 parts per 100 parts of the polyphenylalkylsiloxane. It will be seen from comparative example 6 that an additional aliquot of 50 parts of the polyphenylalkylsiloxane does not have this beneficial effect.

The results in Table 2 indicate that incorporating the Kaneka® MS 5203H in the base whilst adding the polyurethane to the curing package leads to the resulting sealant having both good mechanical and adhesion properties in the composition depicted in example 3. It will also be noted that the replacement of the polyurethane by Kaneka® MS S203H does not provide as good mechanical properties as example 3, 4 and 5. It will also be appreciated that higher modulus sealants can be obtained with formulations of example 4 and 5, which is a property sought by the man skilled in the art.

Comparative 8 is intended to depict a formulation similar to that of example 2 in WO 2006/128015 discussed above. It will be noted that such a formulation gives poor adhesion to glass as compared to the present invention.

1. A phenylorganosiloxane composition comprising:
(a) 100 parts by weight of a phenylorganosiloxane having terminal groups selected from —OH or hydrolysable groups and unsaturated groups having a viscosity of at least 10000 mPa.s at 25° C.;
(b) 40 to 75 parts by weight per 100 parts by weight of (a) of
(i) one or more organic polymers having terminal and/or pendent silyl groups containing -OH functional groups or hydrolysable functional groups, or
(ii) one or more organic polymers having terminal and/or pendent silyl groups containing one or more unsaturated groups, selected in accordance with the terminal groups of (a);
(c) 5 to 500 parts by weight of fillers per 100 parts by weight of (a);
(d) a suitable amount of one or more suitable crosslinkers for cross-linking (a) and (b); and
(e) a suitable amount of catalyst.

2. A phenylorganosiloxane composition in accordance with claim 1 wherein the one or more silyl terminated organic polymers (b) are selected from silyl terminated polyurethanes, silyl terminated polyethers, silyl terminated polycarbonates, silyl terminated (meth)acrylates, silyl terminated saturated hydrocarbon polymers, and/or and or mixtures thereof.

3. A phenylorganosiloxane composition in accordance with claim 1 wherein filler (c) comprises one or more finely divided, reinforcing fillers selected from high surface area fumed and precipitated silicas, calcium carbonate and/or one or more finely divided, semi-reinforcing or non-reinforcing fillers selected from crushed quartz, diatomaceous earths, barium sulphate, iron oxide, titanium dioxide and carbon black, talc, wollastonite, aluminite, calcium sulphate (anhydrite), gypsum, calcium sulphate, magnesium carbonate, clays aluminium trihydroxide, magnesium hydroxide, graphite, copper carbonate, nickel carbonate, barium carbonate, strontium carbonate, aluminium oxide, silicates from the group consisting of olivine group silicates; garnet group silicates; aluminosilicates; ring silicates; chain silicates; and sheet silicates.

4. A phenylorganosiloxane composition in accordance with claim 1 wherein phenylorganosiloxane (a) and the one or more silyl terminated organic polymers (b) contain groups selected from —OH or hydrolysable groups and cross-linker (d) is selected from one or more of a disilaalkanes, alkyltrialkoxysilanes, alkenyltrialkoxy silanes, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-(methylethylketoximo)silane, methyltris(methylethylketoximino)silane, methyltris(isopropenoxy)silane, vinyltris (isopropenoxy)silane, ethylpolysilicate, n-propylorthosilicate, ethylorthosilicate and dimethyltetraacetoxydisiloxane, alkylalkenylbis (N-alkylacetamido) silanes, dialkylbis(N-arylacetamido) silanes; alkylalkenylbis(N-arylacetamido) silanes, or dimethyldi-(N-phenylacetamido)silane.

5. A phenylorganosiloxane composition in accordance with claim 4 wherein catalyst (e) is a condensation catalyst selected from organic tin IV metal catalysts, tin II catalysts, 2-ethylhexoates of iron, cobalt, manganese, lead and zinc, optionally chelated titanates and optionally chelated zirconates.

6. A phenylorganosiloxane composition in accordance with claim 1, wherein phenylorganosiloxane (a) and the one or more silyl terminated organic polymers (b) contain unsaturated groups and cross-linker (d) is selected from one or more organohydrogensiloxane molecules having at least 3 silicon-bonded hydrogen atoms per molecule in an amount which is sufficient to give a molar ratio of Si—H groups in the organohydrogensiloxane to the total amount of alkenyl groups in polymers (a) and (b) of from 1/1 to 10/1.

7. A phenylorganosiloxane composition in accordance with claim 6 wherein catalyst (e) is a platinum group hydrosilylation catalyst containing platinum, rhodium, iridium, palladium or ruthenium.

8. A phenylorganosiloxane composition in accordance with claim 1 further comprising one or more extenders, plasticizers, adhesion promoters, light stabilizers and/or fungicides.

9. A phenylorganosiloxane composition in accordance with claim 1 wherein organic polymer (b) has terminal silyl groups or pendent silyl groups.

10. A phenylorganosiloxane composition in accordance with claim 1 wherein organic polymer (b) is a mixture of two or more organic polymers.

11. A phenylorganosiloxane composition in accordance with claim 1 wherein the composition is stored in two or more parts prior to use.

12. A phenylorganosiloxane composition in accordance with claim 11 wherein the composition is stored in two parts comprising a first part containing polymer (a) and filler (c), and a second part containing crosslinker (d).

13. A phenylorganosiloxane composition in accordance with claim 12 wherein organic polymer (b) is retained in both the first part and the second part.

14. A phenylorganosiloxane composition in accordance with claim 13 wherein one organic polymer (b) is present in the first part and a second organic polymer (b) is present in the second part.

15. (canceled)

16. A method of sealing a space between two units, said method comprising applying a composition in accordance with claim 1 and causing or allowing the composition to cure.

17. A glazing structure or building unit which includes a sealant derived from a composition according to claim 1.

18. A phenylorganosiloxane composition in accordance with claim 6 wherein organic polymer (b) has terminal silyl groups or pendent silyl groups.
